(19) United States
(12) Patent Application Publication
(10) Pub. No.: US 2025/0022203 A1
(43) Pub. Date: Jan. 16, 2025

(54) RUNTIME MOTION ADAPTATION FOR PRECISE CHARACTER LOCOMOTION

(71) Applicants: DISNEY ENTERPRISES, INC., Burbank, CA (US); ETH Zürich (Eidgenössische Technische Hochschule Zürich), Zürich (CH)

(72) Inventors: Noureddine GUEDDACH, Taipei City (TW); Steven Charles POULAKOS, Zürich (CH); Robert Walker SUMNER, Zürich (CH)

(21) Appl. No.: 18/771,451

(22) Filed: Jul. 12, 2024

Related U.S. Application Data
(60) Provisional application No. 63/513,520, filed on Jul. 13, 2023.

(51) Int. Cl. G06T 13/40

(52) U.S. Cl. CPC G06T 13/40; G06T 2213/12

(57) ABSTRACT

The present invention sets forth a technique for performing automated motion adaptation in an animated sequence. The technique includes generating a set of one or more motion sequences based on motion capture data and selecting one of the set of motion sequences based on a score function value. The technique also includes adapting the selected motion sequence such that the adapted motion sequence, when applied to an animation character model, causes the animation character model to move from a specified starting position associated with the animation character to a specified goal position associated with the animation character.

### CROSS-REFERENCE TO RELATED APPLICATIONS

This application claims priority benefit of United States Provisional Patent Application titled “RUNTIME MOTION ADAPTATION FOR PRECISE CHARACTER LOCOMOTION,” Ser. No. 63/513,520, filed Jul. 13, 2023. The subject matter of this related application is hereby incorporated herein by reference.

### BACKGROUND

### Field of the Various Embodiments

Embodiments of the present disclosure relate generally to computer animation and, more specifically, to techniques for performing automated motion adaptation in an animated sequence.

### Description of the Related Art

Character animation is a critical component of virtual production platforms, games, augmented reality, virtual reality, and other interactive applications. In character animation, a locomotion model generates a series of movements associated with an animated character. The series of movements may include steady-state continuous motion, such as walking or running. The series of movements may also include smaller, more precise motions such as side steps and turns that are necessary for the animated character to arrive at a particular goal location and/or goal orientation. For example, a character may need to arrive at a specific location and assume a specific orientation to interact with an element of a virtual environment, such as a chair.

Existing techniques for performing character animation may rely on motion capture data collected from the recorded movements of a live actor to generate locomotion models. These locomotion models may analyze the recorded actor movements to generate one or more novel animation sequences based on one or more segments of the recorded actor movements. While these locomotion models are generally sufficient for continuous motion such as walking, they generally do not model a wide variety of different character motions and do not provide fine user control to generate small, precise adjustments to an animated character's position and/or orientation.

Other existing techniques may train a neural controller on a data set including motion capture data and employ the neural controller to generate novel character animations. Neural controllers may model a wide variety of character motions, but the neural controllers may be unpredictable in operation and generate unrealistic or otherwise unsuitable animation results. Training a neural controller may also require a large amount of motion capture training data that is costly to create, computationally expensive to process, or simply unavailable. Further, existing techniques may not be computationally performant given a limited amount of computing resources in a computing platform such as a portable computer or tablet computer. Without adequate storage, processing capability, and/or memory capacity, existing techniques may not be suitable for real-time adaptation of character animation in, e.g., augmented reality, telepresence, or video game applications.

As the foregoing illustrates, what is needed in the art are more effective techniques for performing automated motion adaptation in an animated sequence.

### SUMMARY

One embodiment of the present invention sets forth a technique for performing automated motion adaptation. The technique includes generating a set of one or more motion sequences based on motion capture data and selecting one of the set of motion sequences based on a score function value. The technique further includes adapting the selected motion sequence such that the adapted motion sequence, when applied to an animation character model, causes the animation character model to move from a specified starting position associated with the animation character to a specified goal position associated with the animation character.

One technical advantage of the disclosed techniques relative to the prior art is that the disclosed techniques allow for subtle, precise movements to cause an animated character to arrive at a specified goal location and/or goal orientation. Further, the disclosed techniques require a limited amount of motion capture data to generate controllable, realistic character animation sequences. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the adaptation engine of FIG. 1, according to some embodiments.

FIG. 3 is an example depiction of a motion capture plan, according to some embodiments.

FIG. 4 is a flow diagram of method steps for performing automated motion adaptation, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

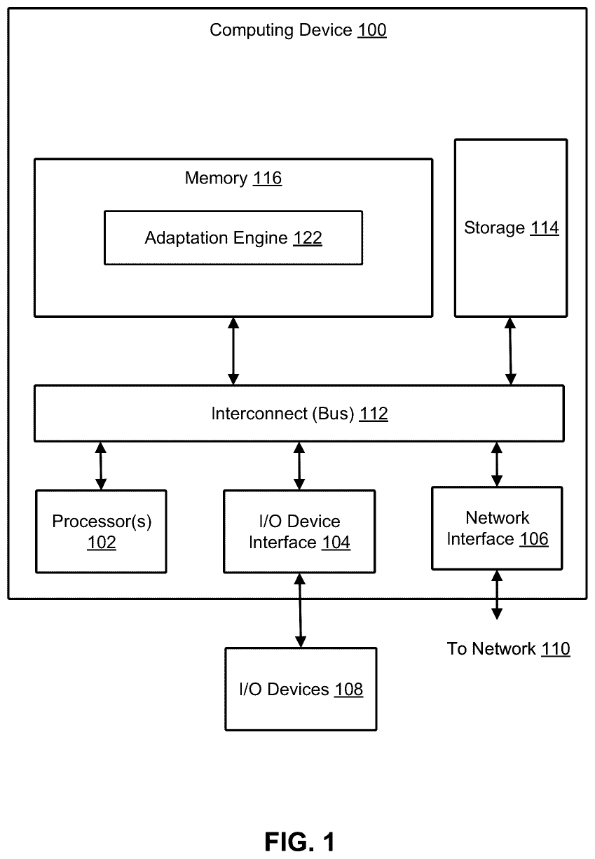

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an adaptation engine 122 that resides in a memory 116.

It is noted that the computing device described herein is illustrative and that any other technically feasible configurations fall within the scope of the present disclosure. For example, multiple instances of adaptation engine 122 could execute on a set of nodes in a distributed and/or cloud computing system to implement the functionality of computing device 100. In another example, adaptation engine 122 could execute on various sets of hardware, types of devices, or environments to adapt adaptation engine 122 to different use cases or applications. In a third example, adaptation engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Adaptation engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including adaptation engine 122.

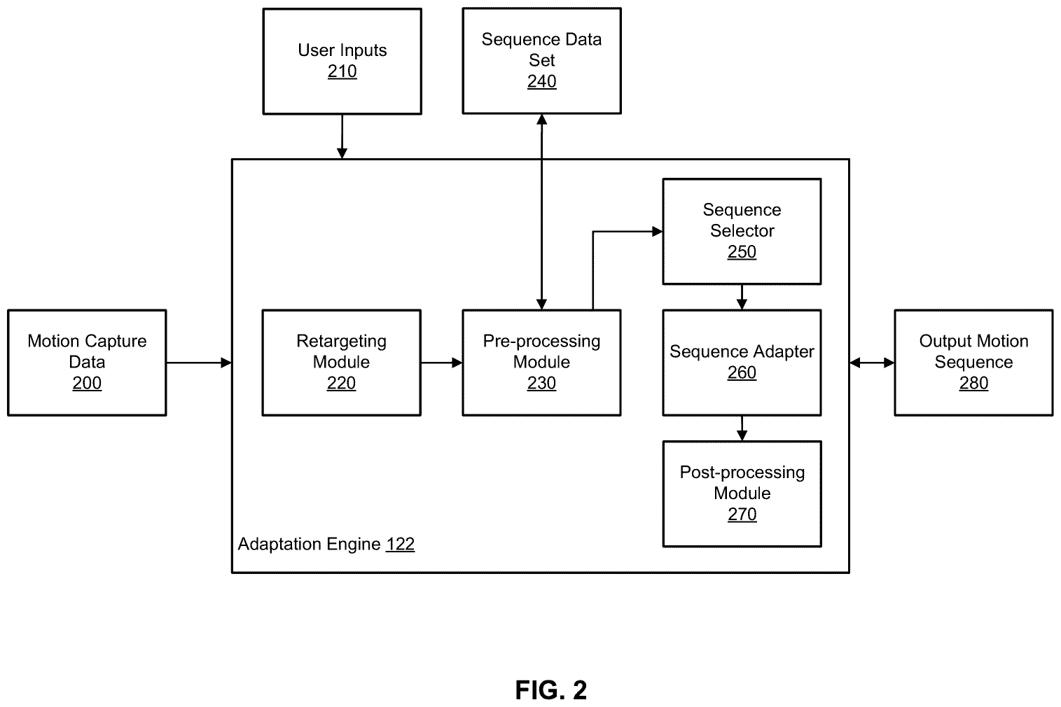

FIG. 2 is a more detailed illustration of adaptation engine 122 of FIG. 1, according to some embodiments. Adaptation engine 122 receives user inputs 210, including a starting position, goal position, and goal orientation associated with an animated character model. Adaptation engine 122 also receives motion capture data 200 including recorded movements of a human actor. Adaptation engine 122 pre-processes motion capture data 200 and generates sequence data set 240. Adaptation engine 122 generates an output motion sequence 280 that represents the movement of the animated character model from the starting position to the goal position and goal orientation based on transforming or otherwise adapting a selected sequence included in sequence data set 240. Adaptation engine 122 includes, without limitation, retargeting module 220, pre-processing module 230, sequence selector 250, sequence adapter 260, and post-processing module 270.

Motion capture data 200 includes recorded movements of one or more human actors. In various embodiments, a human actor is equipped with one or more sensors, targets, or reflectors corresponding to locations on the actor's body, such as joints or bones. The movements of the human actor are recorded based on the positions of the sensors, targets, or reflectors as detected by one or more cameras, receivers, or positioning devices. In various embodiments, a motion capture plan prescribes one or more actor movements to be recorded, where each actor movement begins and ends with the actor standing stationary in an idle pose.

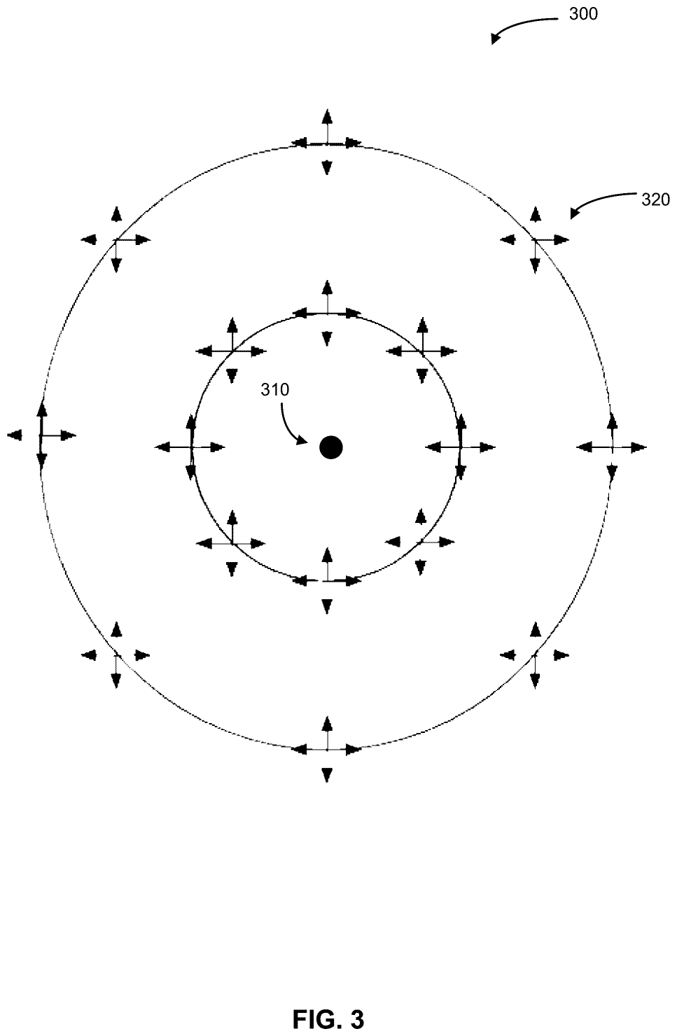

Turning to FIG. 3, FIG. 3 is an example depiction of motion capture plan 300, according to some embodiments. Motion capture plan 300 includes a starting location 310 and multiple ending locations, e.g., ending location 320. During motion capture, the movements of a human actor are continuously recorded while the human actor moves from starting location 310 to one of the multiple ending locations and returns to starting location 310. Upon reaching an ending location, the human actor assumes one of multiple possible orientations represented by arrows associated with each ending location included in motion capture plan 300. In various embodiments, the upward-pointing arrow associated with ending location 320 indicates that the human actor should end their movement at ending location 320 in a north-facing orientation. Similarly, leftward-, rightward-, and downward-pointing arrows may represent west-facing, east-facing, and south-facing ending orientations, respectively.

In various embodiments, after the actor reaches one of the multiple ending locations, the technique re-centers the starting location to the actor's current position and records the actor's return movements to original starting location 310. The actor is again recorded while moving from starting location 310 to either a different ending location, or to a previously visited ending location while assuming a different ending orientation. Motion capture recording continues until the actor has performed movement sequences beginning at starting location 310 and ending at each depicted ending location with each depicted orientation. In various embodiments, the motion capture recording also records movement sequences performed while the actor returns to original starting location 310 from each depicted ending location and orientation, as described above. The recorded motion capture data is stored in motion capture data 200. For example, FIG. 3 includes sixteen ending locations, and four ending orientations at each ending location. Including the return trip associated with each combination of ending location and ending orientation, motion capture data 200 would include 16×4×2=128 different recorded actor movement sequences. Various embodiments of the disclosed invention may include more or fewer ending locations than are depicted in FIG. 3, as well as more, fewer, or different ending orientations than are depicted in FIG. 3.

Turning back to FIG. 2, retargeting module 220 optionally adjusts joint and/or bone positions included in motion capture data 200 to compensate for size and/or proportional differences between a reference skeleton (the human actor) and a target skeleton (an animated character). Retargeting module 220 receives a reference skeleton pose associated with the human actor and a target skeleton pose associated with the animated character. In various embodiments, each of the reference and target skeleton poses includes a depiction of the actor or character in a predetermined pose, such as a T-pose, where the skeleton is positioned upright with legs together and arms extended to the sides. In the reference skeleton pose, each bone is expressed in its parent reference frame. Specifically, each bone is expressed in the reference frame of the reference skeleton as a 4×4 transformation matrix. The transformation matrix is then interpreted as a transformation matrix in the reference frame of the target skeleton. The transformation matrix is expressed in world coordinates M_{bone} ^{world} and multiplied by a retargeting matrix M_{Retargeting} to generate a retargeted bone matrix M(ret)_{bone}^{world}:

$${M ( ret )}_{bone}^{world} = {M}_{Retargeting} \cdot {M}_{bone}^{world} , \qquad ( Equation 1 )$$

$$where$$

$${M}_{Retargeting} = {M}_{parent}^{world} \cdot {M}_{target}^{parent} \cdot {( {M}_{ref}^{parent} )}^{- 1} \cdot {M}_{world}^{parent}$$

Retargeting module 220 transmits the generated retargeted bone matrix to pre-processing module 230.

Pre-processing module 230 receives motion capture data 200 and the generated retargeted bone matrix from retargeting module 220. Pre-processing module 230 analyzes motion capture data 200 and generates sequence data set 240 based on motion capture data 200.

Pre-processing module 230 converts motion capture data 200 into a sequence of frames, where each frame includes joint positions and joint rotations associated with the human actor skeleton. For each frame, pre-processing module 230 optionally adjusts the position of each joint included in the frame based on the retargeted bone matrix discussed above.

Pre-processing module 230 analyzes the adjusted motion capture data 200 and determines velocities associated with a root and one or more feet included in the human actor skeleton. In various embodiments, the root is associated with a particular location in the human actor skeleton, such as the geographic center of the pelvis, rather than being associated with a particular bone or joint. A non-zero velocity associated with the root of the human actor skeleton indicates that the human actor is in motion, while a zero or near-zero velocity associated with the root indicates that the human actor is idle. Each of the one or more feet may have an associated velocity, with a zero or near-zero foot velocity indicating that the associated foot is in contact with the ground and stationary. For each frame of converted motion capture data 200, pre-processing module 230 determines and records velocities associated with the root and the one or more feet.

Pre-processing module 230 extracts motion sequences from converted motion capture data 200 based on the recorded foot and root velocities described above. Each short motion sequence begins and ends with the human actor skeleton positioned in a stationary idle pose. Pre-processing module 230 calculates a function value ƒ associated with each frame included in adjusted motion capture data 200:

$$f = \frac{1}{2} ( {s}_{root} + max ( {s}_{root} , {s}_{left} , {s}_{right} ) ) \qquad ( Equation 2 )$$

where sᵣₒₒₜ indicates the recorded velocity associated with the root included in the human actor skeleton and s_{left} and s_{right} represent the recorded velocities associated with the left and right feet included in the human actor skeleton.

In various embodiments, pre-processing module 230 applies a symmetric low-pass filter to the calculated values of ƒ across all frames included in the motion sequence and determines frames associated with one or more local minima values included in ƒ. Pre-processing module 230 may adjust the determined local minima such that they correspond to the true local minima of the non-filtered function ƒ by performing a local minimum search within a small window of frame values included in the non-filtered function ƒ and thus obtaining the true minima and associated frames. These true local minima correspond to frames included in adjusted motion capture data 200 where the human actor skeleton is in an idle position. Pre-processing module 230 divides motion capture data 200 into motion sequences based on the true local minima, where each motion sequence begins and ends with the human actor skeleton in an idle position.

For each motion sequence included in adjusted motion capture data 200, pre-processing module 230 identifies and records one or more foot contacts within the sequence where one or both of the human actor's feet are in contact with the ground. In post-processing module 270 described below, adaptation engine 122 analyzes the animation character motion based on the one or more recorded foot contacts to prevent foot sliding. Foot sliding in an animation sequence is generally undesirable and occurs when a foot included in the animation character model moves relative to the ground while in contact with the ground.

For each motion sequence included in adjusted motion capture data 200, pre-processing module 230 analyzes joint rotation values for each joint included in the motion sequence. For each frame of the motion sequence, pre-processing module 230 records joint rotation values for each joint about the x-, y-, and z-axes of the joint's parent reference frame. Pre-processing module 230 calculates and records a range of axis-specific rotation values for each joint based on the joint rotation values, including upper and lower bounds associated with the axis-specific rotation values. In post-processing module 270 described below, adaptation engine 122 compares the joint rotation values included in an adapted motion sequence to the calculated range of axis-specific rotation values for each joint to detect unnatural or unrealistic joint rotation values.

Pre-processing module 230 stores the motion sequences extracted from motion capture data 200 in sequence data set 240. Each of the motion sequences included in sequence data set 240 includes associated joint and root positions for each frame include in the motion sequence. Each of the motion sequences may also include joint and root velocities for each frame include in the motion sequence, as well as recorded foot contacts associated with the motion sequence.

Each of the motion sequences in sequence data set 240 corresponds to one of the human actor motion sequences prescribed by motion capture plan 300 described above. Each of the motion sequences in sequence data set 240 begins at the same origin location and ends at one of the goal locations and goal orientations specified in motion capture plan 300. In various embodiments, sequence data set 240 may reside within adaptation engine 122 or may be stored locally or remotely within an enterprise computing environment or within a remote cloud storage system.

Sequence selector 250 calculates a score function value associated with one or more of the motion sequences included in sequence data set 240 based on characteristics associated with the motion sequence and user inputs 210, including an initial position, goal position, and goal orientation associated with an animated character model. Sequence selector 250 selects a motion sequence based on the calculated score function values. In sequence adapter 260 described below, adaptation engine 122 modifies the selected motion sequence such that the selected motion sequence, when applied to the animated character model, causes the animated character to move from the animated character's initial position to the goal position and to assume the goal orientation.

Sequence selector 250 converts the initial position, goal position, and goal orientation included in a motion sequence into the reference frame of the animated character model. For each motion sequence included in sequence data set 240, sequence selector 250 calculates an ending position e for the motion sequence in the reference frame of the animated character model. Sequence selector 250 calculates an angle α between the ending orientation included in the motion sequence and the goal orientation for the animated character. Sequence selector 250 also calculates a stretch o associated with the motion sequence representing an amount that the movement trajectory included in the motion sequence must be stretched or compressed for the ending position e associated with the motion sequence to match the animated character goal position p. In various embodiments, sequence selector 250 normalizes the angle α based on a user-defined maximum angle αₘₐₓ and normalizes the stretch σ by a user-defined maximum stretch σₘₐₓ. In various embodiments, sequence selector 250 considers and scores only motion sequences in which the distance between the sequence ending position e and the animated character goal position p is less than a predetermined radius R.

Sequence selector 250 calculates a score function value for one or more motion sequences included in sequence data set 240:

$$score = [ 1 - max ( \frac{α}{{α}_{ma x}} , \frac{σ}{{σ}_{ma x}} ) ] 𝕀 \{ ‖ e - p ‖ < R \} ; \qquad ( Equation 3 )$$

Sequence selector 250 selects the motion sequence having the highest score function value as determined by Equation (3). In the case where none of the motion sequences included in sequence data set 240 have an associated ending position e that is within the predetermined radius R of the goal position p, adaptation engine 122 may abort the sequence selection. Adaptation engine 122 may then reposition the animated character model closer to goal position p via any conventional animation locomotion technique and re-attempt sequence selection based on the new animation character starting position.

In various embodiments, adaptation engine 122 may verify the selected motion sequence to ensure that subsequent adaptation of the motion sequence as discussed below in the description of sequence adapter 260 will not place any joints included in the character animation model in an unrealistic position. Adaptation engine 122 uniformly samples every nth frame (e.g. n=5) of the motion sequence, simulates adapting the sampled frames, and verifies the resulting joint rotations against the upper and lower bounds calculated by pre-processing module 230 as described above. If the resulting joint rotations fall outside the calculated bounds, adaptation engine 122 may discard the selected motion sequence and select a different motion sequence via sequence selector 250.

Sequence adapter 260 transforms the body bone trajectories included in the selected motion sequence such that the transformed body bone trajectories, when applied to the character animation model, cause the character animation model to move from the initial character position to the goal position and goal orientation. Sequence adapter 260 generates a set of transformation matrices associated with the root, left foot, and right foot positions included in the motion sequence. In various embodiments, sequence adapter 260 adapts the remaining bones based on the positions of the left foot, right foot and root via conventional animation techniques, such as forward kinematics or inverse kinematics.

For the motion sequence, each bone in each frame is expressed in a single reference frame, the Sequence Reference Frame (Seq). For each frame ƒ, sequence adapter 260 transforms the bone data from the Seq reference frame to the world space. As an example, sequence adapter 260 generates a transformation matrix β associated with the left foot. Sequence adapter 260 generates transformation matrices associated with the right foot and the root in a similar manner. Sequence adapter 260 converts β from the Seq reference frame to the adapted foot reference frame (AdaptedFootRef) and computes β in the world reference frame:

$${M}_{β}^{world} = {M}_{AdaptedFootRef}^{world} \cdot {M}_{Seq}^{AdaptedFootRef} \cdot {M}_{β}^{Seq} \qquad ( Equation 4 )$$

Mₐ^{b} represents the matrix that transforms a to b, or in other words, the matrix that represents a in the reference frame of b. To express the bone β from the sequence reference Seq to the adapted reference frame, sequence adapter 260 converts β into the original foot reference frame:

$${M}_{β}^{FootRef} = {M}_{Seq}^{FootRef} \cdot {M}_{β}^{Seq} \qquad ( Equation 5 )$$

Sequence adapter 260 generates a scaled representation M_{β}^{FootRef} of the bone in the adapted foot reference frame, allowing sequence adapter 260 to scale the overall trajectory of the bone up or down during the adaptation:

$${M}_{β}^{AdaptedFootRef} = S \cdot {M}_{β}^{FootRef} \qquad ( Equation 6 )$$

The scaling factor S is based on the ratio between the Euclidean distance between the start and end foot position in the original motion sequence and the Euclidean distance between the start and end foot position in the adapted sequence. Sequence adapter 260 generates the matrix M_{β}^{world} to express the bone in the world coordinate system:

$$\begin{matrix}{M}_{β}^{world} = {M}_{AdaptedFootRef}^{world} \cdot {M}_{β}^{AdaptedFootRef} \\ = {M}_{AdaptedFootRef}^{world} \cdot S \cdot {M}_{β}^{FootRef} \\ = {M}_{AdaptedFootRef}^{world} \cdot S \cdot {M}_{S e q}^{Foot} \cdot {M}_{β}^{Seq} \\ = {M}_{AdaptedFootRef}^{world} \cdot S \cdot {( {M}_{FootRef}^{Seq} )}^{- 1} \cdot {M}_{β}^{Seq}\end{matrix} \qquad ( Equation 7 )$$

Sequence adapter 260 generates the final Adaptation Transformation Matrix M_{Adaptation}:

$${M}_{Adaptation} = {M}_{AdaptedFootRef}^{world} \cdot S \cdot {( {M}_{FootRef}^{Seq} )}^{- 1} \qquad ( Equation 8 )$$

Sequence adapter 260 generates the Adaptation Transformation Matrix via a function TRS that creates a transformation matrix from a translation, rotation and scaling triplet and a quaternion matrix. Sequence adapter 260 generates M_{AdaptedFoodtRef}^{world}, M_{FootRef}^{Seq}, and S based on the desired world foot start position s, the desired world foot end position e, the sequence foot start position s_{seq}, the sequence foot end position e_{seq}, the quaternion Quat(v) with forward vector v, the identity quaternion Q_{Id}, the zero vector 0 and the all-one vector 1:

$${M}_{AdaptedFootRef}^{world} = T R S ( s , Quat ( e - s ) , 1 ) \\ {M}_{FootRef}^{Seq} = T R S ( {s}_{seq} , Quat ( {e}_{seq} - {s}_{seq} ) , 1 ) \\ S = T R S ( 0 , {Q}_{Id} , \frac{‖ e - s ‖}{‖ {e}_{seq} - {s}_{seq} ‖} ) \qquad ( Equation 9 )$$

Sequence adapter 260 generates adaptation matrices associated with the other foot and the root in the same manner. Sequence adapter generates the three adaptation matrices once upon selection of a motion sequence and then applies the adaptation matrices to the selected motion sequence to generate an adapted sequence.

For each driver bone (i.e., feet and root) included in the motion sequence, sequence adapter 260 adapts each frame included in the selected motion sequence via multiplying the bone matrix M_{β}^{Seq} by the computed adaptation matrix:

$${M}_{β , Adapted} = {M}_{Adaptation} \cdot {M}_{β}^{Seq} \qquad ( Equation 10 )$$

Equation 10 above explicitly adapts the positions of the bones included in the motion sequence. Sequence adapter 260 adapts the implicit rotations of the bones included in the motion sequence via a quaternion slerping (spherical linear interpolation) technique based on a normalized sequence time t∈[0,1]. For a rotation Rₒ implicitly embedded in the adapted bone matrix M_{β, Adapted}, the initial rotation Rᵢ at the start of the motion sequence, and the goal orientation rotation R_{ƒ}, sequence adapter 260 calculates the final adapted rotation at time t:

$${Rot}_{Adapted} = Slerp ( Slerp ( {R}_{o} , {R}_{i} , {( 1 - t )}^{9} ) , Slerp ( {R}_{o} , {R}_{f} , {t}^{9} ) , t ) \qquad ( Equation 11 )$$

Sequence adapter 260 inserts the adapted rotation into the adapted bone matrix M_{β, Adapted}. The high-degree polynomials for t (e.g. (1−t)⁹ and t⁹) in Equation 11 ensure that the effect of the initial rotation quickly fades away after the start of the motion sequence and that the effect of the final rotation only begins near the end of the motion sequence.

For each driven bone included in the motion sequence, i.e. any bone other than a root or foot bone, sequence adapter 260 expresses the bone in the reference frame of its driver bone and multiplies the bone matrix by the driver bone's adaptation matrix:

$$\begin{matrix}{M}_{β , Adapted} = {M}_{Adapt . , driver ( β )} \cdot {M}_{β}^{driver ( β )} \\ = {M}_{Adapted . , driver ( β )} \cdot {M}_{Seq}^{driver ( β )} \cdot {M}_{β}^{Seq} \\ = {M}_{Adapt . , driver ( β )} \cdot {( {M}_{driver ( β )}^{Seq} )}^{- 1} \cdot {M}_{β}^{Seq}\end{matrix} \qquad ( Equation 12 )$$

As an example, a foot is the driver bone for the toe bones associated with the foot. For a knee bone, the driver bones are the root and the corresponding foot, and sequence adapter 260 averages the resulting adaptations based on each of the root and the foot adaptations. For all other bones, the root is the driver bone. After adapting each frame of the selected motion sequence, sequence adapter transmits the adapted motion sequence to post-processing module 270.

Post-processing module 270 analyzes the adapted motion sequence to detect and correct or minimize inaccuracies, discontinuities, or other visual artifacts present in the adapted motion sequence. In various embodiments, post-processing module 270 addresses foot sliding, enforces joint constraints, performs foot collision avoidance, and blends the adapted motion sequence into adjacent animation character movement sequences.

As discussed above, foot sliding describes the condition where a foot included in an animation model moves while in contact with the ground. To minimize foot sliding in the adapted motion sequence, post-processing module 270 leverages the knowledge of specific frames included in the adapted motion sequence in which either or both feet are in contact with the ground. Pre-processing module 230 previously identified and recorded these specific frames as discussed above.

For one or more frames included in the adapted motion sequence in which a foot is in contact with the ground, post-processing module 270 adjusts the frames to lock the foot in the ground plane, rendering the foot horizontally immobile with respect to the ground. In various embodiments, post-processing module 270 may minimize abrupt movements when the contact between the foot and the ground ends by partially locking the foot with a weighting factor between 0 and 1 for a short duration, e.g. 100-200 ms, after contact between the foot and the ground ends. In various embodiments, post-processing module 270 does not fully lock joint rotations during frames in which a foot is in contact with the ground, to allow for ankle rotation. Post-processing module 270 may partially lock the joint rotation with a weighting factor of, e.g., 0.5 during frames in which a foot is in contact with the ground.

The adaptation technique performed by sequence adapter 260 as described above adapts the rotation of each joint independently. As a result, a parent joint may not point to its child joint after adaptation. For example, a shoulder joint should point to its corresponding elbow joint, and an elbow joint should point to its corresponding hand joint. Misalignments between parent and child joints may introduce unwanted visual artifacts in the adapted motion sequence. Post-processing module 270 adjusts the rotation of each joint in a hierarchical manner such that each joint points to its child joint. Similarly, the adaptation technique performed by sequence adapter 260 adapts the position of each joint independently, which may cause one or more limbs to be slightly stretched. Post-processing module 270 adjusts the position of each joint to preserve correct limb lengths in the adapted motion sequence.

The adaptation technique performed by sequence adapter 260 may result in collisions between the animated character's feet in the adapted motion sequence. For example, with the character's left foot stationary on the ground and the character's right foot swinging forward past the stationary left foot, the character's right and left feet may collide. Post-processing module 270 generates a lateral offset associated with the moving right foot that varies depending on the distance between the right and left feet. As the distance between the feet decreases, post-processing module 270 increases the value of the lateral offset to keep the moving right foot from colliding with the stationary left foot.

In various embodiments, adaptation engine 122 may append the adapted motion sequence generated by sequence adapter 260 to the beginning or end of a motion sequence generated by conventional animation locomotion techniques. To minimize visual discontinuities at or near the transition between the adapted motion sequence and the conventionally generated motion sequence, post-processing module 270 may blend the adapted motion sequence into the conventionally generated motion sequence. In an example where post-processing module 270 blends the end of the adapted motion sequence into the beginning of a conventionally generated motion sequence, post-processing module 270 calculates a linear interpolation between one or more frames near the end of the adapted motion sequence and a beginning frame of the conventionally generated motion sequence. In various embodiments, post-processing module 270 may calculate the linear interpolation based on an interpolation factor that increases to 1 at or near the end of the adapted sequence. Post-processing module 270 generates output motion sequence 280.

Output motion sequence 280 includes an animated character motion sequence that moves the animated character from the user-specified starting position to the user-specified goal position and goal orientation. As discussed above, adaptation engine 122 may append output motion sequence 280 to the beginning or end of a different motion sequence, including a conventionally generated motion sequence.

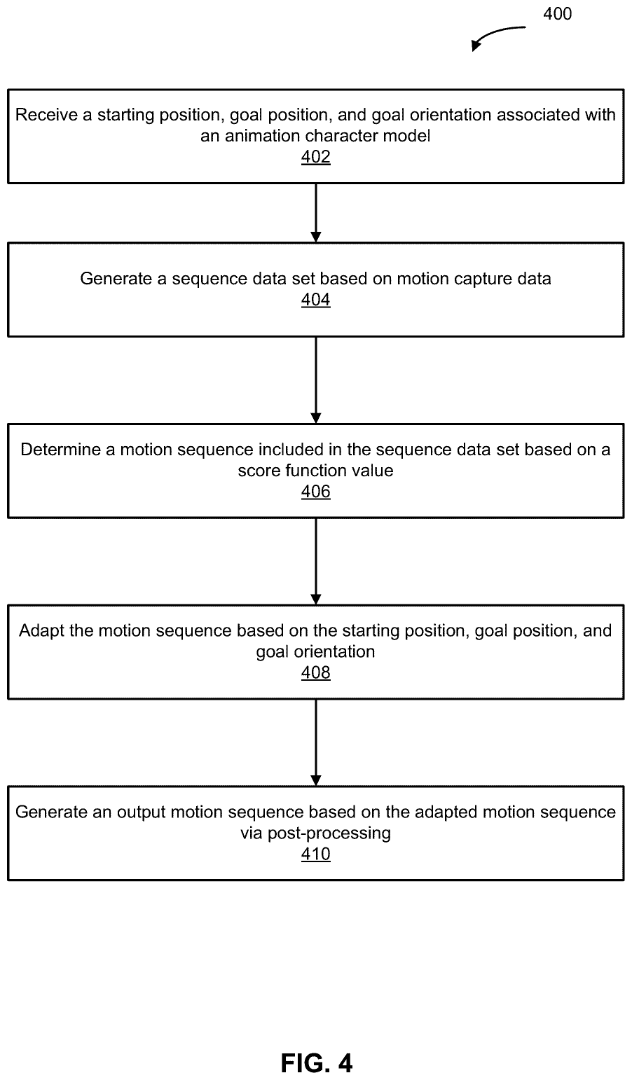

FIG. 4 is a flow diagram of method steps for performing automated motion adaptation, according to some embodiments. Although the method steps are described in conjunction with the systems of FIGS. 1 and 2, persons skilled in the art will understand that any system configured to perform the method steps in any order falls within the scope of the present disclosure.

As shown, in step 402 of method 400, adaptation engine 122 receives a starting position, a goal position, and a goal orientation associated with an animation character model. The starting position, goal position, and goal orientation are expressed in world coordinates associated with the animation character model.

In step 404, adaptation engine 122 generates sequence data set 240 based on motion capture data 200. Via retargeting module 220, adaptation engine 122 optionally adjusts motion capture data 200 based on size and/or proportion differences between a human actor skeleton included in motion capture data 200 and a skeleton included in the animation character model. Pre-processing module 230 of adaptation engine 122 analyzes the adjusted motion capture data and calculates foot and root velocities for each frame included in motion capture data 200. Based on the calculated foot and root velocities, pre-processing module 230 divides motion capture data 200 into a set of motion sequences, where each motion sequence represents the movement of a human actor from a fixed origin position to a final position and final orientation, as prescribed by motion capture plan 300 discussed above. Pre-processing module 230 also calculates and records frames included in each motion sequence in which one or more of the human actor's feet are stationary with respect to the ground.

In step 406, adaptation engine 122 determines, via sequence selector 250, a motion sequence included in sequence data set 240. Sequence selector calculates a score function value for each motion sequence included in sequence data set 240. The score function value is based on the extent to which the motion sequence must be adapted for the adapted motion sequence to move the animated character from the animated character's starting position to the animated character's goal position and goal orientation.

In step 408, adaptation engine 122 adapts the determined motion sequence via sequence adapter 260. Sequence adapter 260 generates adaptation matrices based on characteristics associated with the motion sequence and the starting position, goal position and goal orientation associated with the animation character model. For each frame included in the motion sequence, sequence adapter 260 multiplies one or more of the generated adaptation matrices by a bone matrix associated with the animation character model to adapt the positions and/or rotations of bones and joints included in the animation character model. The adapted motion sequence, when applied to the animation character model, causes the animation character model to move from the starting position associated with the animation character model to the goal position and goal orientation specified for the animation character model.

In step 410, post-processing module 270 of adaptation engine 122 adjusts the adapted motion sequence to minimize foot sliding, enforce joint constraints, and prevent foot collisions. Post-processing module 270 may also blend the adapted motion sequence into the beginning or end of a different animation motion sequence, including conventionally generated motion sequences. After post-processing, adaptation engine 122 generates output motion sequence 280.

In sum, the disclosed techniques perform automated motion adaptation in a character animation sequence. In various embodiments, the automated motion adaptation may include receiving a specified goal location and orientation for an animated character, selecting one of a set of pre-recorded motion sequences based on a scoring algorithm, and adapting the pre-recorded motion sequence to cause the animated character to arrive at the specified goal location and goal orientation.

In operation, an adaptation engine receives motion capture data including pre-recorded live actor motions. Each motion captures the movement of the live actor as the actor moves from a specified origin location to one of a number of specified ending locations. At the end of each motion, the actor assumes a specified orientation, e.g., facing north, south, east, or west. The adaptation engine divides the motion capture data into individual motion sequences, such that each motion sequence begins with the actor positioned at the same origin location and ends with the actor positioned at one of the specified ending locations and having a specific orientation.

The adaptation engine receives a current location for an animated character and a desired goal location and orientation for the animated character. The current location, goal location, and orientation may be specified in the world coordinate system. The adaptation engine analyzes the current and goal locations and selects one of the pre-recorded motion sequences based on a score function value associated with the pre-recorded motion sequence. The score function value may be based on how closely a combination of the starting location and pre-recorded motion sequence matches the goal location and orientation for the animated character. If none of the pre-recorded motion sequences receive an acceptable score function value, the adaptation engine may generate an intermediate motion sequence that moves the animated character to an updated character location that is within a threshold distance of the goal location before repeating the score function value calculation for the pre-recorded motion sequences based on the updated character location. In various embodiments, the adaptation engine may generate the intermediate motion sequence via any conventional locomotion system, e.g., a locomotion system included in a commercial animation package, or a neural controller.

The adaptation engine adapts a selected motion sequence such that the adapted motion sequence precisely locates the animated character at the goal location with the specified orientation. The adaptation engine generates a set of transformation matrices associated with bones or other components included in the character animation model, such as a left foot, a right foot, and a root. For each frame of the pre-recorded motion sequence, the adaptation engine adapts the pose of the animated character based on matrix multiplications between bone matrices and the generated transformation matrices. The adaptation engine may also adjust the starting and ending rotation of bones or other components included in the character animation model to precisely align the character animation model with the desired ending orientation.

The adaptation engine may also verify the selected motion sequence to ensure that, after adaptation, the movements of one or more individual joints included in the character animation model do not violate a calculated range of motion associated with the individual joint. Prior to adapting an entire selected motion sequence, the adaptation engine may initially adapt a subset of frames included in the selected motion sequence and verify the joint movements for the subset of frames. If the adaptation engine verifies that the joint movements of the adapted motion sequence are acceptable, the adaptation engine may adapt the remainder of frames included in the pre-recorded motion sequence.

The adaptation engine may perform post-processing on the adapted motion sequence to enhance the appearance of the adapted motion sequence or to correct errors in bone or joint positioning in the adapted motion sequence. The post-processing may include corrective measures to alleviate foot sliding, where a foot included in the character animation model exhibits unnatural movement relative to the ground while in contact with the ground. The post-processing may also adjust the rotational position of one or more joints included in the character animation model to ensure that each joint points to its child point in the character animation model. For example, post-processing may adjust the rotation of a shoulder joint such that the shoulder joint points to the elbow joint, or adjust the rotation of an elbow joint such that the elbow joint points to a hand joint. The post-processing may also correct collisions between the character animation model's feet by incorporating a varying lateral separation distance between the feet during movement. In some cases, the adapted motion sequence may be appended onto the beginning or end of a different motion sequence generated via the disclosed techniques or via a different locomotion technique. In these cases, post-processing may include blending the adapted motion sequence into the beginning or end of the different motion sequence. The adaptation engine may blend the adapted motion sequence via weighted linear interpolation between frames of the adapted motion sequence and one or more frames of the different motion sequence.

The adaptation engine may also retarget the motion capture data to adapt the motion capture data for use with a character animation model having a different skeletal shape compared to the skeletal shape of the live actor from whom the motion data was captured. The adaptation engine generates a retargeting matrix that, when applied to the motion capture data, adjusts the positions of bones and joints included in the motion capture data to match the corresponding bone and joint positions in the character animation model.

One technical advantage of the disclosed techniques relative to the prior art is that the disclosed techniques allow for subtle, precise movements to cause an animated character to arrive at a specified location and/or orientation. Further, the disclosed techniques require a limited amount of motion capture data in order to generate controllable, realistic character animation sequences. These technical advantages provide one or more technological improvements over prior art approaches.

1. In some embodiments, a computer-implemented method for performing automated motion adaptation comprises generating a set of one or more motion sequences based on motion capture data, selecting one of the set of motion sequences based on a score function value, and adapting the selected motion sequence such that the adapted motion sequence, when applied to an animation character model, causes the animation character model to move from a specified starting position associated with the animation character to a specified goal position associated with the animation character.

2. The computer-implemented method of clause 1, wherein the motion capture data includes one or more recordings based on movements of a human actor.

3. The computer-implemented method of clauses 1 or 2, wherein a motion capture plan prescribes a starting position, ending position, and ending orientation of the human actor.

4. The computer-implemented method of any of clauses 1-3, wherein each motion sequence included in the set of motion sequences begins at a same origin location.

5. The computer-implemented method of any of clauses 1-4, wherein the score function value is based on at least a distance between an ending position associated with a motion sequence and the specified goal position associated with the animation character.

6. The computer-implemented method of any of clauses 1-5, where the score function value is further based on an angle between an ending orientation associated with the motion sequence and a specified goal orientation associated with the animation character.

7. The computer-implemented method of any of clauses 1-6, further comprising analyzing, for each frame included in the motion capture data, velocities associated with one or more bones included in the motion capture data.

8. The computer-implemented method of any of clauses 1-7, further comprising adjusting the adapted motion sequence to prevent foot sliding in adapted motion sequence, enforce joint constraints in the adapted motion sequence, or avoid foot collisions in the adapted motion sequence.

9. The computer-implemented method of any of clauses 1-8, wherein adapting the selected motion sequence further comprises multiplying one or more adaptation matrices by one or more bone matrices associated with the animation character model.

10. The computer-implemented method of any of clauses 1-9, wherein each of the one or more motion sequences begins and ends in an idle position.

11. In some embodiments, one or more non-transitory computer-readable media store instructions that, when executed by one or more processors, cause the one or more processors to perform the steps of generating a set of one or more motion sequences based on motion capture data, selecting one of the set of motion sequences based on a score function value, and adapting the selected motion sequence such that the adapted motion sequence, when applied to an animation character model, causes the animation character model to move from a specified starting position associated with the animation character to a specified goal position associated with the animation character.

12. The one or more non-transitory computer-readable media of clause 11, wherein the motion capture data includes one or more recordings based on movements of a human actor.

13. The one or more non-transitory computer-readable media of clauses 11 or 12, wherein a motion capture plan prescribes a starting position, ending position, and ending orientation of the human actor.

14. The one or more non-transitory computer-readable media of any of clauses 11-13, wherein each motion sequence included in the set of motion sequences begins at a same origin location.

15. The one or more non-transitory computer-readable media of any of clauses 11-14, wherein the score function value is based on at least a distance between an ending position associated with a motion sequence and the specified goal position associated with the animation character.

16. The one or more non-transitory computer-readable media of any of clauses 11-15, where the score function value is further based on an angle between an ending orientation associated with the motion sequence and a specified goal orientation associated with the animation character.

17. In some embodiments, a system comprises one or more memories storing instructions, and one or more processors for executing the instructions to generate a set of one or more motion sequences based on motion capture data, select one of the set of motion sequences based on a score function value, and adapt the selected motion sequence such that the adapted motion sequence, when applied to an animation character model, causes the animation character model to move from a specified starting position associated with the animation character to a specified goal position associated with the animation character.

18. The system of clause 17, wherein the motion capture data includes one or more recordings based on movements of a human actor.

19. The system of clauses 17 or 18, wherein a motion capture plan prescribes a starting position, ending position, and ending orientation of the human actor.

20. The system of any of clauses 17-19, wherein each motion sequence included in the set of motion sequences begins at a same origin location.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing automated motion adaptation, the method comprising:
generating a set of one or more motion sequences based on motion capture data;
selecting one of the set of motion sequences based on a score function value; and
adapting the selected motion sequence such that the adapted motion sequence, when applied to an animation character model, causes the animation character model to move from a specified starting position associated with the animation character to a specified goal position associated with the animation character.

2. The computer-implemented method of claim 1, wherein the motion capture data includes one or more recordings based on movements of a human actor.

3. The computer-implemented method of claim 2, wherein a motion capture plan prescribes a starting position, ending position, and ending orientation of the human actor.

4. The computer-implemented method of claim 1, wherein each motion sequence included in the set of motion sequences begins at a same origin location.

5. The computer-implemented method of claim 1, wherein the score function value is based on at least a distance between an ending position associated with a motion sequence and the specified goal position associated with the animation character.

6. The computer-implemented method of claim 5, where the score function value is further based on an angle between an ending orientation associated with the motion sequence and a specified goal orientation associated with the animation character.

7. The computer-implemented method of claim 1, further comprising analyzing, for each frame included in the motion capture data, velocities associated with one or more bones included in the motion capture data.

8. The computer-implemented method of claim 1, further comprising adjusting the adapted motion sequence to prevent foot sliding in adapted motion sequence, enforce joint constraints in the adapted motion sequence, or avoid foot collisions in the adapted motion sequence.

9. The computer-implemented method of claim 1, wherein adapting the selected motion sequence further comprises multiplying one or more adaptation matrices by one or more bone matrices associated with the animation character model.

10. The computer-implemented method of claim 1, wherein each of the one or more motion sequences begins and ends in an idle position.

11. One or more non-transitory computer-readable media storing instructions that, when executed by one or more processors, cause the one or more processors to perform the steps of:
generating a set of one or more motion sequences based on motion capture data;
selecting one of the set of motion sequences based on a score function value; and
adapting the selected motion sequence such that the adapted motion sequence, when applied to an animation character model, causes the animation character model to move from a specified starting position associated with the animation character to a specified goal position associated with the animation character.

12. The one or more non-transitory computer-readable media of claim 11, wherein the motion capture data includes one or more recordings based on movements of a human actor.

13. The one or more non-transitory computer-readable media of claim 12, wherein a motion capture plan prescribes a starting position, ending position, and ending orientation of the human actor.

14. The one or more non-transitory computer-readable media of claim 11, wherein each motion sequence included in the set of motion sequences begins at a same origin location.

15. The one or more non-transitory computer-readable media of claim 11, wherein the score function value is based on at least a distance between an ending position associated with a motion sequence and the specified goal position associated with the animation character.

16. The one or more non-transitory computer-readable media of claim 15, where the score function value is further based on an angle between an ending orientation associated with the motion sequence and a specified goal orientation associated with the animation character.

17. A system comprising:
one or more memories storing instructions; and
one or more processors for executing the instructions to:
generate a set of one or more motion sequences based on motion capture data;
select one of the set of motion sequences based on a score function value; and
adapt the selected motion sequence such that the adapted motion sequence, when applied to an animation character model, causes the animation character model to move from a specified starting position associated with the animation character to a specified goal position associated with the animation character.

18. The system of claim 17, wherein the motion capture data includes one or more recordings based on movements of a human actor.

19. The system of claim 18, wherein a motion capture plan prescribes a starting position, ending position, and ending orientation of the human actor.

20. The system of claim 17, wherein each motion sequence included in the set of motion sequences begins at a same origin location.
